(19) United States
(12) Patent Application Publication
(10) Pub. No.: US 2020/0347653 A1
(43) Pub. Date: Nov. 5, 2020

(54) SECURITY DOOR SYSTEM

(71) Applicant: ALPIN MANAGEMENT PARTNERS LTD., Houston, TX (US)

(72) Inventor: DAVID DUNSTAN, Houston, TX (US)

(73) Assignee: ALPIN MANAGEMENT PARTNERS LTD., Houston, TX (US)

(21) Appl. No.: 16/770,113

(22) PCT Filed: Dec. 7, 2017
(86) PCT No.: PCT/US2017/065171

§ 371 Date: Jun. 5, 2020

(51) Int. Cl. E05C 19/00; E05B 47/02; E05B 63/00

(52) U.S. Cl. CPC E05C 19/001; E05B 2047/0068; E05B 63/0052; E05B 47/026

(57) ABSTRACT

Methods, systems, and devices for securing a door including a security assembly comprising at least one frame member with a slot. The security assembly may include a blade at least partially received in the slot and an actuator within the cavity. The blade may substantially traverse the length of the edge surface of the door in the closed position and be extendable from the slot toward the edge surface. The actuator may be configured to move the blade between a retracted position and an extended position. The security assembly includes an endcap configured to cover a corresponding edge surface of the door and including an opposing well slot configured to at least partially receive the blade when the blade is in the extended position, and thereby prevent movement of the door.

### FIELD OF THE DISCLOSURE

This disclosure pertains generally to security doors.

### BACKGROUND OF THE DISCLOSURE

Security techniques and devices for home or business doors have evolved over the years. Various types of locks and reinforcement members have been employed to secure conventional doors. Conventional locks often include a latch assembly or bolt incorporated in the door that is received by a strike plate mounted on the door jamb.

### SUMMARY OF THE DISCLOSURE

In aspects, the present disclosure provides methods, systems, and devices for securing a door fitted to an opening formed in a wall and movable between a closed position and open positions. The door may have a first face and a second face opposing the first face. Apparatus embodiments include a security assembly comprising at least one frame member configured to be mountable in the opening. Each frame member of the at least one frame member may include a body configured for installation in alignment with the opening such that the body extends along a face of the opening, the body comprising a cavity, a jamb surface configured to be aligned with a location of a corresponding edge surface of the door in the closed position, and a slot in the jamb surface substantially traversing the length of the edge surface. The security assembly may include a blade at least partially received in the slot and an actuator within the cavity. The blade may substantially traverse the length of the edge surface of the door in the closed position and be extendable from the slot toward the edge surface. The actuator may be configured to move the blade between a retracted position and an extended position. The security assembly may be configured for each blade to prevent movement of the door at the corresponding edge surface of the door in the closed position when in the extended position.

The door may have a plurality of edge surfaces and the at least one frame member may include a plurality of frame members. Each frame member of the plurality of frame members may correspond to an edge surface of the door in the closed position and be aligned therewith. The plurality of frame members may include at least one corresponding frame member aligned with each edge surface of the plurality of edge surfaces. The at least one frame member may include a sill member, and the jamb surface may be a sill surface.

The security assembly may comprise an endcap for each frame member. The endcap may be configured to cover a corresponding edge surface of the door. The endcap may comprise an opposing well slot configured to at least partially receive the blade when the blade is in the extended position, and thereby prevent movement of the door. The security assembly may be configured for the blade of each frame member to engage the opposing well slot in the corresponding edge surface of the door in the closed position when in the extended position. The slot, the blade, and the opposing slot may be aligned in a common plane, the common plane being between the first face and the second face when the door is in the closed position. The system may include a door with opposing well slots configured to at least partially receive the blades when the blades are in the extended position and thereby prevent movement of the door. A switch mechanism may be configured to toggle the actuator.

The blade in the extended position blocks travel of the door by being in the path of at least one of the first face and the second face. The security assembly is configured for at least one blade to engage a plurality of frame members in the extended position.

Another apparatus embodiment may include a security assembly including a plurality of frame members configured to be mountable in the opening, each frame member of the plurality of frame members corresponding to an edge surface of the door, each frame member comprising: a body configured for installation in alignment with the opening such that the body extends along a face of the opening, a blade at least partially received in the slot. The blade may substantially traverse the length of the edge surface and be extendable from the slot toward the edge surface. The body may include a cavity, a jamb surface configured to be aligned with a location of a corresponding edge surface of the door in the closed position, and a slot in the jamb surface substantially traversing the length of the edge surface. The security assembly may also include an actuator within the cavity, the actuator configured to move the blade between a retracted position and an extended position; a plurality of endcaps configured to cover each edge surface of the door, the endcaps comprising opposing well slots configured to at least partially receive the blades when the blades are in the extended position and thereby prevent movement of the door; and a switch mechanism configured to toggle the actuator. The security assembly may be configured for each blade to engage the opposing well slot in the corresponding edge surface of the door in the closed position when in the extended position. The slot, the blade, and the opposing slot are aligned in a common plane, the common plane being between the first face and the second face when the door is in the closed position. The plurality of frame members may include at least one frame member aligned with a location associated with a closed orientation of the door for each edge surface of the plurality of edge surfaces.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1A-1D illustrate a security apparatus in accordance with embodiments of the present disclosure.

FIG. 2 illustrates a security assembly in accordance with embodiments of the present disclosure.

FIGS. 3A & 3B illustrate other security assemblies in accordance with embodiments of the present disclosure.

FIGS. 4A-4C illustrate actuators in accordance with embodiments of the present disclosure.

### DETAILED DESCRIPTION

In aspects, the present disclosure relates to devices and methods for securing a door fitted to an opening formed in a wall. The door is conventionally movable between a closed position and one of various open positions. In particular, embodiments of the present disclosure are directed to a security assembly which provides improved security for the opening.

One issue with conventional security locks is that resistance to opening the door is concentrated at a very small point. Application of a shock force on this point is often enough to compromise the door or the lock and enable entry. In contrast, aspects of the present disclosure provide distributed support for the door.

The security assembly includes at least one frame member configured to be mountable in the opening, with each frame member including a body configured for installation in alignment with the opening such that the body extends along a face of the opening. The body includes a cavity, a jamb surface configured to be aligned with a location of a corresponding edge surface of the door in the closed position, and a slot in the jamb surface substantially traversing the length of the corresponding edge surface.

The security assembly also includes a translatable blade, or other frame extension member, at least partially received in the slot. The blade may be a steel blank or the like. The blade substantially traverses the length of the edge surface of the door in the closed position and is extendable from the slot toward the edge surface. An actuator within the cavity is configured to move the blade between a retracted position and an extended position. Multiple frame members may be configured with respective blades, and in some embodiments, blades may secure substantially the entire perimeter of the door.

When considering the door in a closed position, the security assembly may be configured so that each blade, when in the extended position, prevents movement of the door at the corresponding edge surface. In this way, in the extended position, the blade both locks and provides structural support for the door in a distributed manner.

Illustrative systems according to this disclosure employ devices that provide engageable distributed reinforcement. The teachings may be advantageously applied to a variety of doors residentially, commercially, and in various other settings. Merely for clarity, examples of certain non-limiting embodiments will be discussed below.

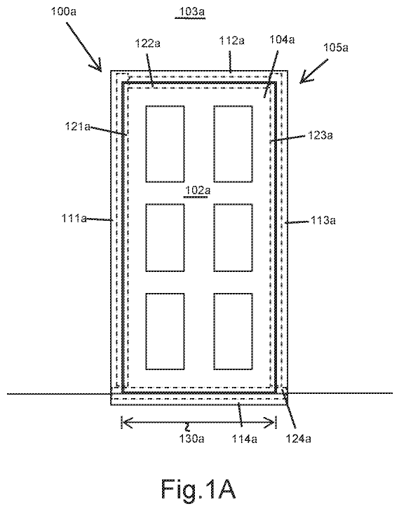

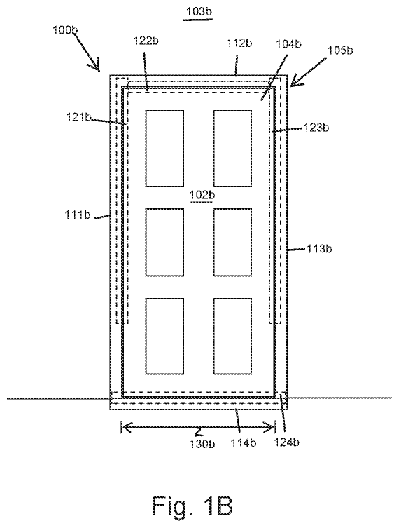

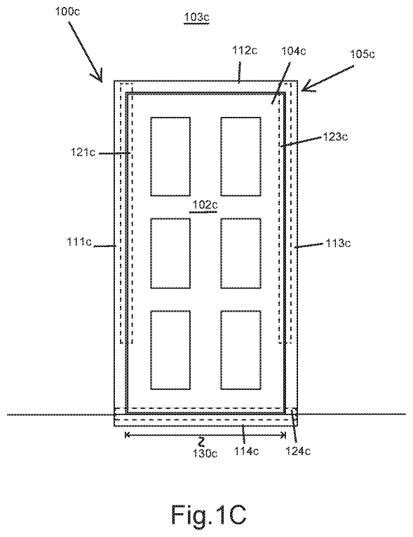

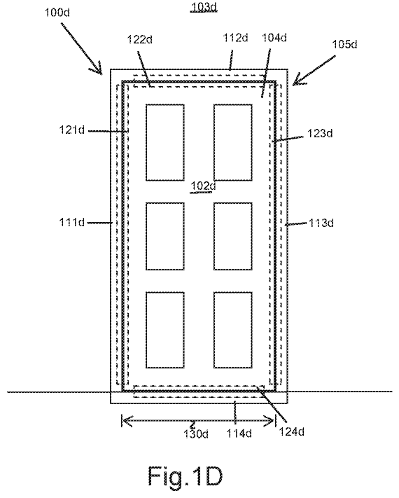

FIGS. 1A-1D illustrate security apparatus in accordance with embodiments of the present disclosure. Referring to FIG. 1A, the apparatus 100a is configured to secure a door 104a fitted to an opening formed in a wall 103 and movable between a closed position and open positions. The door 104a is shown in a closed position with a view of a first face 102a of the door 104a. A second face opposite the first face is not shown.

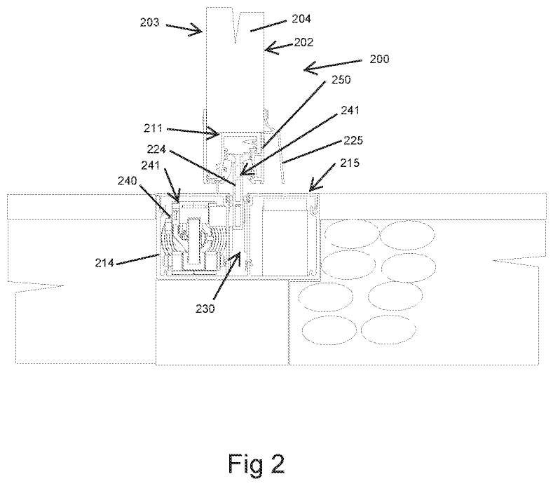

The apparatus 100a includes a security assembly 105 including frame members 111a, 112a, 113a, 114a installed in the opening, with each frame member including a translatable frame extension member 121a, 122a, 123a, 124a, respectively. In some preferred embodiments, translatable frame extension members 121a, 122a, 123a, 124a are implemented as blades at least partially received in a slot of the respective frame members 111a, 112a, 113a, 114a (see FIG. 2A, below). The blades may be configured with a maximum thickness, such as, 1.5 centimeters, less than 1 centimeter, less 5 millimeters, and so on, such that they are easily integrated into the frame member with a minimum of air or moisture intrusion and substantially no fouling of the assembly over time. Each blade may comprise a steel blank or the like. In other embodiments, the blade may be a composite, or an engineered structural component.

Each blade may be extendable from the respective slot toward the edge surface of the door in the closed position. At least one actuator within a cavity in at least one of the frame members 111a, 112a, 113a, 114a may be configured to move the blade between a retracted position and an extended position. Thus, the security assembly 105a is configured for each blade to prevent movement of the door at the corresponding edge surface of the door in the closed position when in the extended position.

FIG. 1B-1D illustrate security apparatus with structure and features sharing similarities with FIG. 1A. The features of FIGS. 1B-1D may decrease costs and complexity, and increase ease of manufacture. Referring to FIG. 1B, the apparatus 100b includes a security assembly 105b including frame members 111b, 112b, 113b, 114b installed in the opening, with frame members 111b, 112b, 113b, 114b including translatable frame extension members 121b, 122b, 123b, 124b, respectively. Neither of translatable frame extension members 121b and 123b traverses the entire length of the edge surface of members 111b and 113b, though the translatable frame extension members substantially traverse the length of their corresponding edge surfaces. Translatable frame extension member 124b traverses the bottom edge of the door 104b, as in FIG. 1A.

Referring to FIG. 1C, the apparatus 100c includes a security assembly 105c including frame members 111c, 112c, 113c, 114c installed in the opening, with frame members 111c, 113c, 114c including a translatable frame extension members 121c, 123c, 124c, respectively. Neither of translatable frame extension members 121b and 123b traverses the entire length of the edge surface of members 111b and 113b, though the translatable frame extension members substantially traverse the length of their corresponding edge surfaces. Translatable frame extension member 124c traverses the bottom edge of the door 104c and the entire length of the edge surface 130c, as in FIG. 1A.

Referring to FIG. 1D, the apparatus 100d includes a security assembly 105d including frame members 111d, 112d, 113d, 114d installed in the opening, with frame members 111d, 112d, 113d, 114d including translatable frame extension members 121d, 122d, 123d, 124d, respectively. Each of translatable frame extension members substantially traverses the length of its corresponding edge surface.

Translatable frame extension members 121a and 123a each comprises a blade extendable from frame members 111a and 113a, respectively, to be received by door 104a and frame member 112. When received thusly, the portions of blades 121a and 123a received by frame members 112a and extending from frame members 111a and 113a, respectively, are supported by a system of two support surfaces, which provide enhanced structural support against intrusion. Translatable frame extension member 124a comprises a blade extendable from frame member 114a to be received by door 104a and the lower edges of frame members 111a and 113a. When received thusly, the portions of blade 124a received by frame members 111a and 113a and extending from frame member 114a are supported by a system of three support surfaces, which provide further enhanced structural support against intrusion. Engaging a blade with a plurality of support surfaces incorporated in the respective frame members as shown increases the security of the door.

FIG. 1B-1D illustrate security apparatus with structure and features sharing similarities with FIG. 1A. The features of FIGS. 1B-1D may decrease costs and complexity, and increase ease of manufacture. Referring to FIG. 1B, the apparatus 100b includes a security assembly 105b including frame members 111b, 112b, 113b, 114b installed in the opening, with frame members 111b, 112b, 113b, 114b including translatable frame extension members 121b, 122b, 123b, 124b, respectively. Neither of translatable frame extension members 121b and 123b traverses the entire length of the edge surface of members 111b and 113b, though the translatable frame extension members substantially traverse the length of their corresponding edge surfaces. Translatable frame extension member 124b traverses the bottom edge of the door 104b, as in FIG. 1A.

Referring to FIG. 1C, the apparatus 100c includes a security assembly 105c including frame members 111c, 112c, 113c, 114c installed in the opening, with frame members 111c, 113c, 114c including a translatable frame extension members 121c, 123c, 124c, respectively. Neither of translatable frame extension members 121b and 123b traverses the entire length of the edge surface of members 111b and 113b, though the translatable frame extension members substantially traverse the length of their corresponding edge surfaces. Translatable frame extension member 124c traverses the bottom edge of the door 104c and the entire length of the edge surface 130c, as in FIG. 1A.

Referring to FIG. 1D, the apparatus 100d includes a security assembly 105d including frame members 111d, 112d, 113d, 114d installed in the opening, with frame members 111d, 112d, 113d, 114d including translatable frame extension members 121d, 122d, 123d, 124d, respectively. Each of translatable frame extension members substantially traverses the length of its corresponding edge surface.

FIG. 2 illustrates a security assembly in accordance with embodiments of the present disclosure. FIGS. 2A & 2B show an apparatus 200 installed to secure a door 204 in a closed position. A first (outside) face 202 of the door and a second (inside) face 203 of the door are parallel with one another and perpendicular to a jamb surface 215 of the frame member 214. The frame member 214 is a sill member, and the jamb surface 215 is implemented here as sill surface comprising a sill top plate. As installed, jamb surface 215 is configured to be aligned with a location of a corresponding edge surface 211 of the door 204 in the closed position. A blade 224 is at least partially received in a slot 230 in the jamb surface 215 and is extendable from the slot 230 toward the edge surface 211. FIG. 2A shows the blade 224 in an extended position.

The security assembly 200 includes an endcap 250 for the frame member 214. The endcap 250 covers the corresponding edge surface 211 of the door 204. The endcap 250 has incorporated an opposing well slot 241 configured to at least partially receive the blade 224 when the blade is in the extended position. Security assembly 200 is thus configured for the blade 224 to engage the opposing well slot 241 in the corresponding edge surface of the door when in the extended position, and thereby prevent movement of the door. This engagement may increase structural stability of the secured (e.g., locked) door. In some embodiments, endcap 250 may be attached to a standard door, such as, for example, appending to a door edge through the use of lag bolts, or through the application of special purpose security fasteners configured to be tamper resistant (e.g., high strength materials, flush mounting).

An actuator 240, residing in a cavity 241, is configured to move the blade 224 between the retracted position and the extended position. Blade 224 may include insulation members 226, such as draught seals, to prevent the exchange of inside and outside air.

Bracket 225 is attached to door 204. Bracket 225 includes a rain deflector to inhibit moisture accumulation in the slot 230. Bracket 225 could additionally or alternatively provide additional structural support. Frame member 214 may be configured and/or installed to be recessed in the floor so that jamb surface 215 may be even with the surrounding floor. This feature allows unimpeded foot travel near the frame and unimpaired access by wheeled conveyance while the blade is retracted.

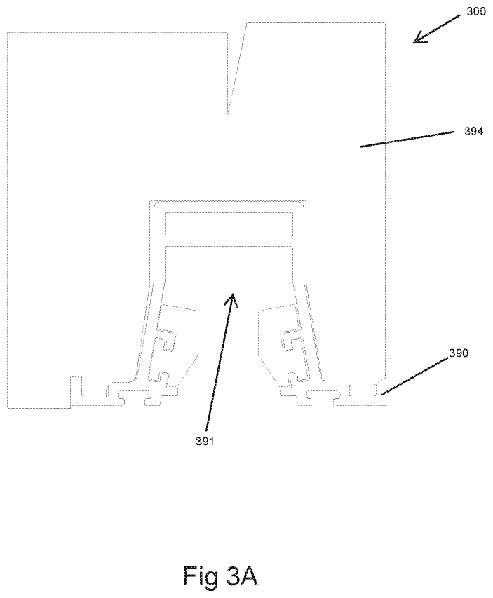

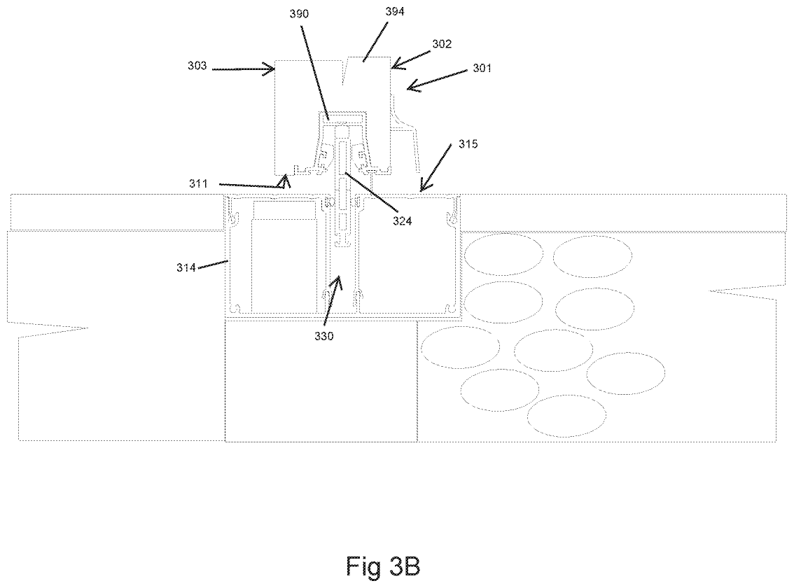

FIGS. 3A & 3B illustrate other security assemblies in accordance with embodiments of the present disclosure. Security assembly 300, shown in FIG. 3A, includes endcap 390, which is attached to a specially configured door 394. Door 394 includes an integrated opposing well slot 391 which runs through both endcap and door. Opposing well slot 391 is configured to at least partially receive the corresponding blade when the blade is in the extended position and thereby prevent movement of the door.

Security assembly 301, shown in FIG. 3B, is configured to secure a door 394 in a closed position. A first (outside) face 302 of the door and a second (inside) face 303 of the door are parallel with one another and perpendicular to a jamb surface 315 of the frame member 314. As installed, jamb surface 315 is configured to be aligned with a location of a corresponding edge surface 311 of the door 304 in the closed position. A blade 324 is at least partially received in a slot 330 in the jamb surface 315 and is extendable from the slot 330 toward the edge surface 311.

Frame member 314 may be configured and/or installed to be recessed in the floor so that jamb surface 315 may be even with the surrounding floor. This feature allows unimpeded foot travel near the frame and unimpaired access by wheeled conveyance while the blade is retracted.

The security assembly 301 includes endcap 390. The endcap 390 covers the corresponding edge surface 311 of the door 304. The endcap 390 has incorporated an opposing well slot 391 configured to at least partially receive the blade 324 when the blade is in the extended position. Security assembly 301 is thus configured for the blade 324 to engage the opposing well slot 391 in the corresponding edge surface of the door when in the extended position, and thereby prevent movement of the door. This engagement may increase structural stability of the secured (e.g., locked) door. In some embodiments, endcap 390 may be attached to a standard door, such as, for example, appending to a door edge through the use of lag bolts, or through the application of special purpose security fasteners configured to be tamper resistant (e.g., high strength materials, flush mounting).

In the examples, above the slot, the blade, and the opposing slot are aligned in a common plane. The common plane may be between the first face and the second face when the door is in the closed position.

The door may have a plurality of edge surfaces and the at least one frame member may include a plurality of frame members. Each frame member of the plurality of frame members may correspond to an edge surface of the door in the closed position and aligned therewith.

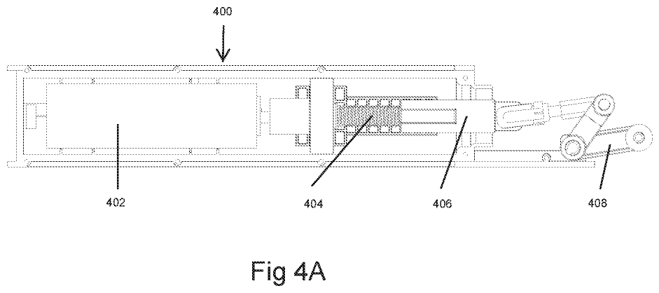

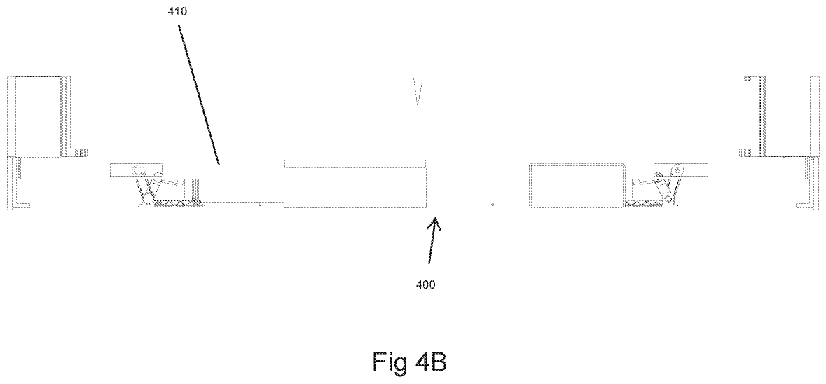

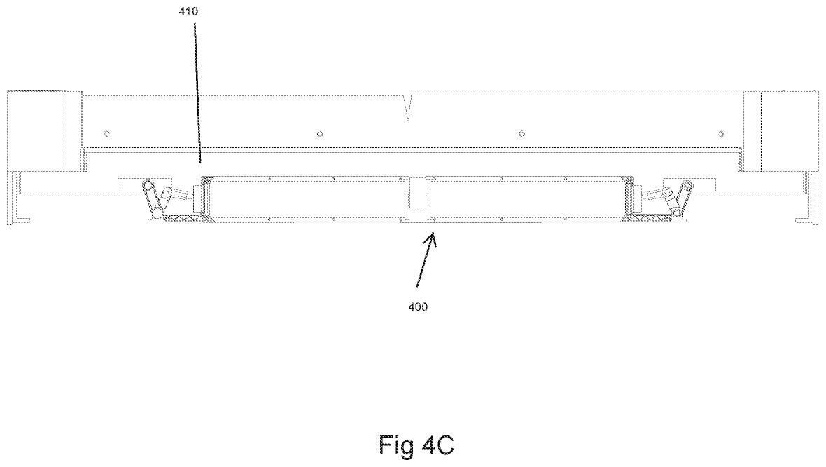

FIGS. 4A-4C illustrate actuators in accordance with embodiments of the present disclosure. Actuator 400 comprises an electric motor 402 which rotates a threaded drive rod 404. The threaded drive rod 404, when rotated, in turn causes an adjuster 406 to translate and thereby a lift arm 408 to smoothly raise the blade 410. The blade 410 may be directly or indirectly operatively coupled to lift arm 408. A switch mechanism configured to toggle the actuator may include a control surface, integrated into the door, attached to a wall, and the like, or may be activated via wireless connection (e.g., Bluetooth, proprietary remote control, etc.).

As would occur to one of ordinary skill in the art, a wide variety of actuators and connecting assemblies may be used to extend the blade or other translatable frame extension member, such as for example, hydraulic, pneumatic, piezoelectric, and so on.

It should be understood that the term “substantially traverse” as used herein refers to traversing at least 70 percent of the referenced length, such as for example, a translatable frame extension member may substantially traverse the length of its corresponding edge surface when extending along at least 70 percent of the length of the corresponding edge surface. Some extension members may extend 80, 90, 99 percent of the length, and so on, including extension members that extend along the length of the surface which are longer than the surface.

While the foregoing disclosure is directed to the one mode embodiments of the disclosure, various modifications will be apparent to those skilled in the art. It is intended that all variations be embraced by the foregoing disclosure.

What is claimed is:

1. An apparatus for securing a door fitted to an opening formed in a wall and movable between a closed position and open positions, the door having a first face and a second face opposing the first face, the apparatus comprising:
a security assembly comprising:
at least one frame member configured to be mountable in the opening, with each frame member of the at least one frame member comprising:
a body configured for installation in alignment with the opening such that the body extends along a face of the opening, wherein the body comprises:
a cavity,
a jamb surface configured to be aligned with a location of a corresponding edge surface of the door in the closed position, and
a slot in the jamb surface substantially traversing the length of the edge surface,
a blade at least partially received in the slot, wherein the blade substantially traverses the length of the edge surface of the door in the closed position and is extendable from the slot toward the edge surface, and
an actuator within the cavity, the actuator configured to move the blade between a retracted position and an extended position; and
wherein the security assembly is configured for each blade to prevent movement of the door at the corresponding edge surface of the door in the closed position when in the extended position.

2. The apparatus of claim 1, wherein door has a plurality of edge surfaces and the at least one frame member comprises a plurality of frame members, each frame member of the plurality of frame members corresponding to an edge surface of the door in the closed position and aligned therewith.

3. The apparatus of claim 2, wherein the plurality of frame members comprises at least one corresponding frame member aligned with each edge surface of the plurality of edge surfaces.

4. The apparatus of claim 1, wherein the at least one frame member includes a sill member, and the jamb surface is a sill surface.

5. The apparatus of claim 1, wherein the security assembly further comprises an endcap for each frame member, the endcap configured to cover a corresponding edge surface of the door, the endcap comprising an opposing well slot configured to at least partially receive the blade when the blade is in the extended position, and thereby prevent movement of the door, the security assembly configured for the blade of each frame member to engage the opposing well slot in the corresponding edge surface of the door in the closed position when in the extended position.

6. The apparatus of claim 5, wherein the slot, the blade, and the opposing slot are aligned in a common plane, the common plane being between the first face and the second face when the door is in the closed position.

7. The apparatus of claim 1, further comprising the door, wherein the door comprises opposing well slots configured to at least partially receive the blades when the blades are in the extended position and thereby prevent movement of the door.

8. The apparatus of claim 1, further comprising a switch mechanism configured to toggle the actuator.

9. The apparatus of claim 1, wherein the blade in the extended position blocks travel of the door by being in the path of at least one of the first face and the second face.

10. The apparatus of claim 1, wherein the security assembly is configured for at least one blade to engage a plurality of frame members in the extended position.

11. An apparatus for securing a door fitted to an opening formed in a wall and movable between a closed position and open positions, the door having a first face and a second face opposing the first face, the apparatus comprising:
a security assembly comprising:
a plurality of frame members configured to be mountable in the opening, each frame member of the plurality of frame members corresponding to an edge surface of the door, each frame member comprising:
a body configured for installation in alignment with the opening such that the body extends along a face of the opening, wherein the body comprises:
a cavity,
a jamb surface configured to be aligned with a location of a corresponding edge surface of the door in the closed position, and
a slot in the jamb surface substantially traversing the length of the edge surface,
a blade at least partially received in the slot, wherein the blade substantially traverses the length of the edge surface and is extendable from the slot toward the edge surface, and
an actuator within the cavity, the actuator configured to move the blade between a retracted position and an extended position; and
a plurality of endcaps configured to cover each edge surface of the door, the endcaps comprising opposing well slots configured to at least partially receive the blades when the blades are in the extended position and thereby prevent movement of the door;
a switch mechanism configured to toggle the actuator;
wherein the security assembly is configured for each blade to engage the opposing well slot in the corresponding edge surface of the door in the closed position when in the extended position, and;
wherein the slot, the blade, and the opposing slot are aligned in a common plane, the common plane being between the first face and the second face when the door is in the closed position.

12. The apparatus of claim 11, wherein the plurality of frame members comprises at least one frame member aligned with a location associated with a closed orientation of the door for each edge surface of the plurality of edge surfaces.
